(19) United States
(12) Patent Application Publication
(10) Pub. No.: US 2006/0028748 A1
(43) Pub. Date: Feb. 9, 2006

(54) Storage system using superparamagnetic particles

(75) Inventor: Reinder Coehoorn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,914

(22) PCT Filed: Oct. 8, 2003
(86) PCT No.: PCT/IB03/04450

§ 371 Date: Apr. 27, 2005

(30) Foreign Application Priority Data
Nov. 4, 2002 (EP) 02079602.5

(51) Int. Cl. G11B 27/36

(52) U.S. Cl. 360/31

(57) ABSTRACT

An information carrier (10) has an information plane that has a pattern of superparamagnetic material constituting an array of storage locations (11). The presence of a specific superparamagnetic material (12R, 12G, 12B, 12Y) at the information plane represents a value of a storage location. The superparamagnetic materials have a specific response to a varying magnetic field, e.g. a known decay time. A storage unit has an interface surface (32) for cooperating with the information plane, and has coils (27) for generating the varying magnetic field. The interface surface has an array of magnetic sensor elements (24,25,26) each having a sensitive area for generating a read signal. A processing unit (33) detects said presence via the specific response by processing the read signal.

The invention relates to a storage system comprising an information carrier and a storage unit.

The invention further relates to an information carrier and a device for storing information.

Data storage systems using magnetic material on an information carrier are well known, for example a removable type magnetic information carrier like the floppy disk or a non removable type like a hard disk.

A storage system, information carrier, and a device for storing information are known from patent U.S. Pat. No. 5,956,216. The document describes a magnetic information carrier of a patterned type. The information carrier has an information plane that is provided with a magnetic layer that can be magnetized by a suitable magnetic field from a write head. In particular the information plane is provided with a non-magnetic substrate and magnetic domain elements that can have two magnetization values. The magnetic domain elements constitute storage locations for storing a single bit of data. The device has a head and a write unit for recording information in a track constituted by the storage locations on the information carrier. The value of a storage location must be set or retrieved by positioning a read/write head opposite the storage location, e.g. by scanning the track. A problem of the known magnetic storage system is that the scanning does not allow random access to any storage location. Positioning the head via a jump to a required part of the track is time consuming. Further the process of storing data in the storage locations for distribution of software to customers is complicated.

Therefore it is an object of the invention to provide a system comprising an information carrier and a device for storing information efficiently at the storage locations and that allows fast access to the storage locations.

According to a first aspect of the invention the object is achieved with a storage system as defined in the opening paragraph, the information carrier having an information plane that is provided with a pattern of superparamagnetic material constituting an array of storage locations, the presence of a specific superparamagnetic material at the information plane representing a value of a storage location, the specific superparamagnetic material having a predefined response to a varying magnetic field, and the storage unit having an interface surface for cooperating with the information plane, which interface surface is provided with field generating means for generating the varying magnetic field, and with an array of magnetic sensor elements each having a sensitive area for generating a read signal, and a processing unit for detecting said presence via the predefined response by processing the read signal.

According to a second aspect of the invention the object is achieved with an information carrier as defined in the opening paragraph, the information carrier having an information plane that is provided with a pattern of superparamagnetic material constituting an array of storage locations, the presence of a specific superparamagnetic material at the information plane representing a value of a storage location, the specific superparamagnetic material having a predefined response to a varying magnetic field.

According to a third aspect of the invention the object is achieved with a storage device as defined in the opening paragraph, characterized in that the device comprises an interface surface for cooperating with the information plane, which interface surface is provided with field generating means for generating the varying magnetic field, and with an array of magnetic sensor elements each having a sensitive area for generating a read signal, and a processing unit for detecting said presence via the predefined response by processing the read signal.

A fixed pattern of material is provided on the information carrier, e.g. in a low-cost manufacturing process like imprinting. The presence or absence of a specific superparamagnetic material at the information plane can be detected by the sensor elements for reading the values of the storage locations. The effect of an array constituted by magnetic sensor elements cooperating with the information plane is that data from a large number of storage locations can be retrieved simultaneously. This has the advantage that data is stored at a high density and low cost, and can be accessed at a high speed due to the parallelism in the read-out.

The invention is also based on the following recognition. The known magnetic storage systems provide information carriers that can be recorded by magnetizing a material in a layer or pattern in a recording device. Further the well known optical discs that provide cheap data distribution are relatively slow and large, and require a scanning mechanism which is sensitive to mechanical shocks. The solid state memory devices like EPROM and MRAM are expensive per bit. The inventors have seen that a new class of storage that combines several advantageous properties of the previous systems can be provided by an information carrier having a pattern of specific superparamagnetic material on a substrate. Such information carrier can be cheaply produced using known manufacture techniques. The material is called superparamagnetic because the material has a predefined response to a change in the magnetic field due to the superparamagnetic effects, in particular a specific relaxation time in response to a change of the field. The presence or absence of the superparamagnetic material is detectable via a varying magnetic field. It is noted that the detection of the value of a storage location does not depend on the magnetic state of the material, but on the presence or absence of the material itself. The magnetic sensor elements generate a read signal corresponding to the field within a predefined near-field working distance from the storage location, which is in practice in the same order of magnitude as the minimum dimensions of the storage location. Suitable magnetic sensor elements can be produced using solid state production methods, e.g. known from producing MRAM magnetic storage devices. The read signal is processed to detect the response of the superparamagnetic material to a change is the field.

In an embodiment of the system the pattern of superparamagnetic material comprises a number of different superparamagnetic materials, the different superparamagnetic materials having respective different predefined responses to the varying magnetic field, in particular the different predefined responses being different decay of magnetization after a decrease of the varying magnetic field due to different relaxation times of the different superparamagnetic materials. This has the advantage that several different superparamagnetic materials that are present within the sensitive area of a single sensor element can be detected by applying a suitable varying field and read signal processing. Hence given the number and size of the sensor elements a large number of values can be retrieved from the information carrier.

Further preferred embodiments of the information carrier and the storage device according to the invention are given in the dependent claims.

These and other aspects of the invention will be apparent from and elucidated further with reference to the embodiments described by way of example in the following description and with reference to the accompanying drawings, in which

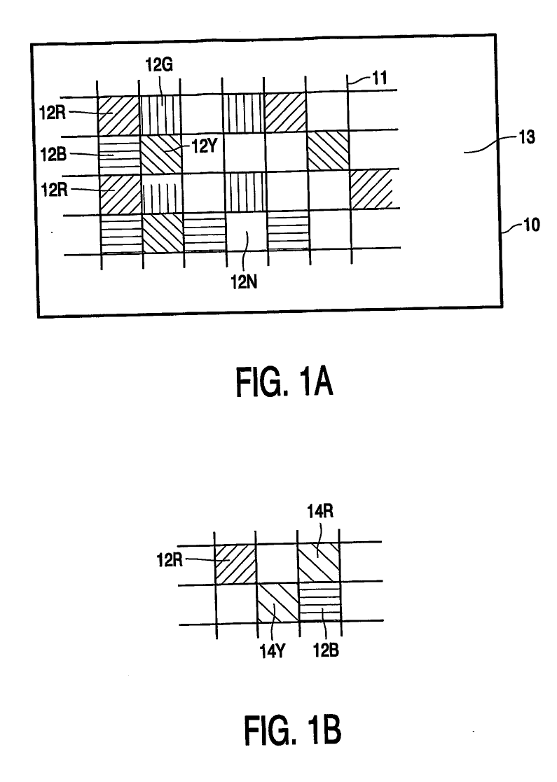

FIG. 1a shows an information carrier part (top view),

FIG. 1b shows a pattern of a superparamagnetic material having grey scale coding,

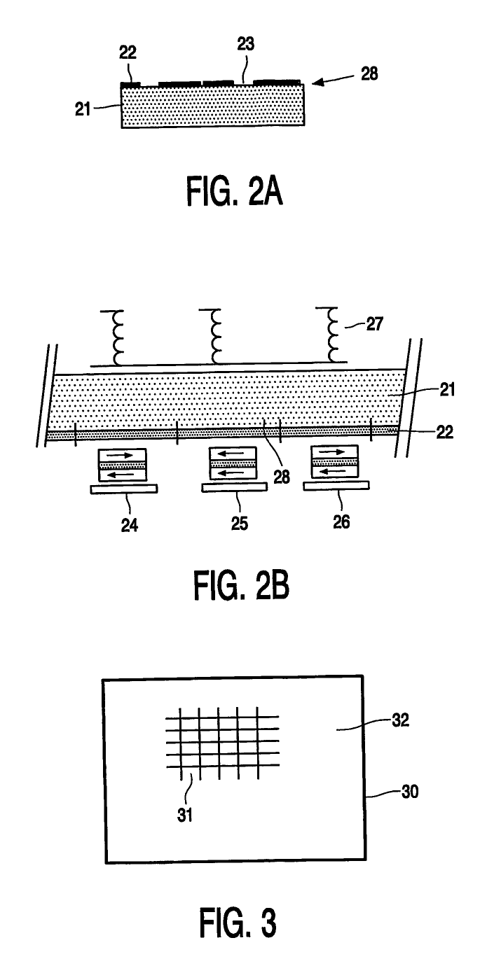

FIG. 2a shows a patterned information carrier part in a cross section view,

FIG. 2b shows an information carrier and magnetic sensor elements,

FIG. 3 shows a read-out unit,

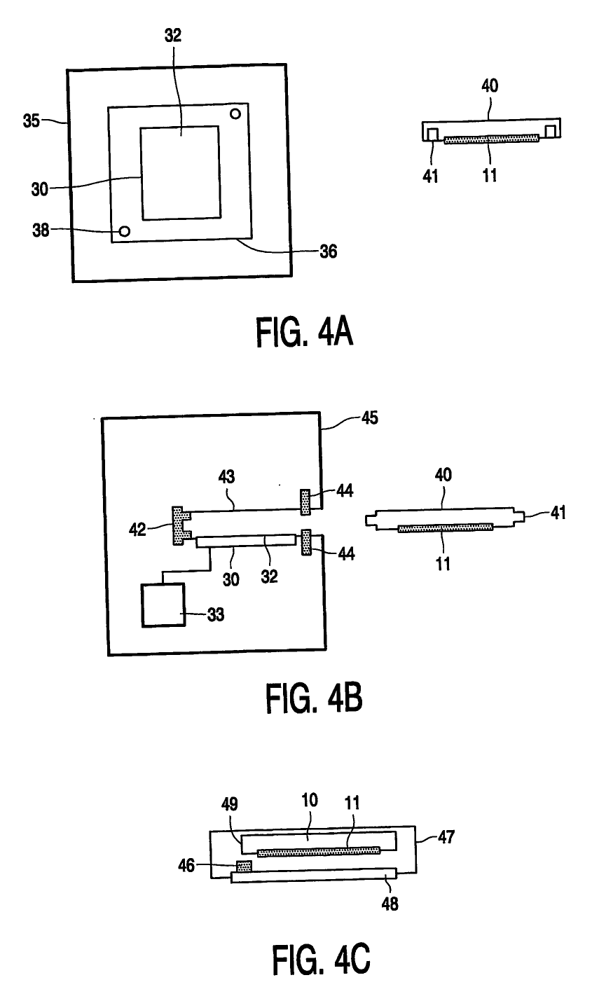

FIG. 4a shows a storage device (top view) and information carrier,

FIG. 4b shows a storage device (side view) and information carrier,

FIG. 4c shows an information carrier in a cartridge,

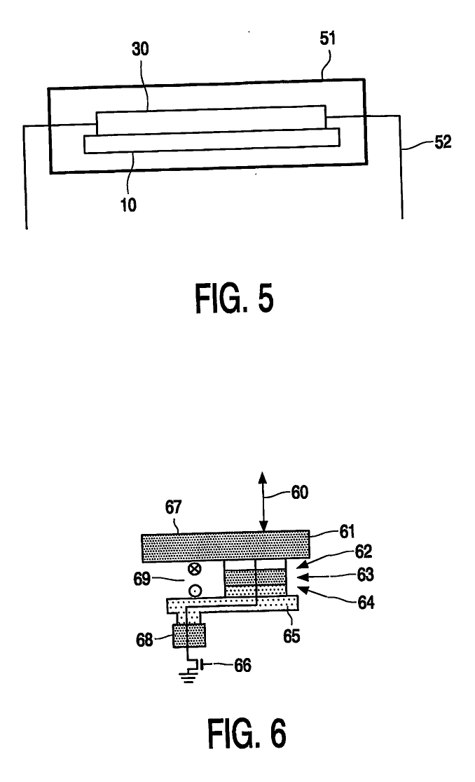

FIG. 5 shows a memory device,

FIG. 6 shows a sensor element in detail,

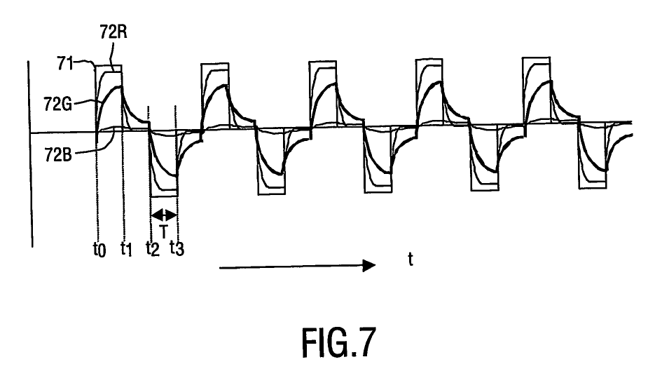

FIG. 7 shows a varying field and responses,

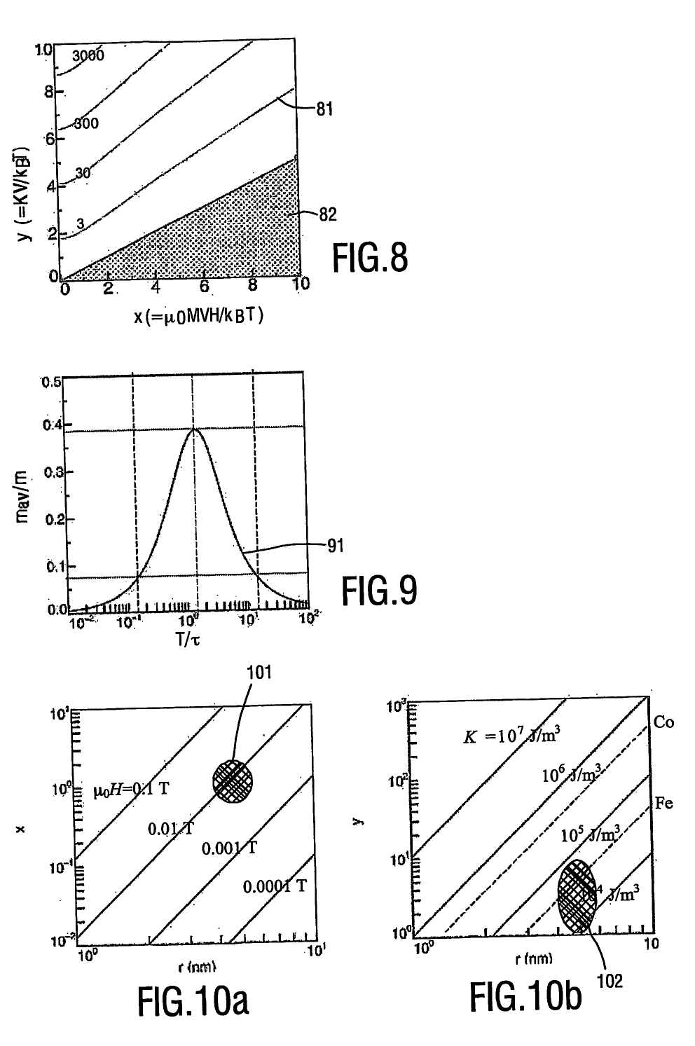

FIG. 8 shows contours of the ratio τ/τ₀,

FIG. 9 shows the average medium magnetization in the field=off phase, and

FIG. 10 shows parameters of the superparamagnetic particles.

In the Figures, elements which correspond to elements already described have the same reference numerals.

FIG. 1a shows an information carrier part (top view). An information carrier part 10 has an information plane that is provided with a pattern of a superparamagnetic material 12 constituting an array of storage locations 11. The presence or absence of the material 12 at the information plane provides a physical parameter for representing a value of a storage location. It is noted that the information plane is situated on a top surface 13 of the information carrier part 10. The top surface 13 of the information carrier part is intended to be coupled to an interface surface of a read-out unit. The information plane is considered to be present at an effective distance from the mechanical top layer, e.g. a thin cover layer for protecting the information plane may constitute the outer layer of the information carrier. Sensor elements in said read-out part are placed near the information plane, but some intermediate material like contamination may be present in between. Hence the effective distance is determined by any intermediate material and the intended read-out sensor elements that have a near-field working distance extending outward from the interface surface towards the information plane. The physical effect of the presence or absence of material at the information plane for reading the information is explained below with reference to FIG. 2b. The pattern of a superparamagnetic material may contain a single superparamagnetic material.

The embodiments shown in FIG. 1 are based on four types of superparamagnetic particles with different relaxation times (called 12R=red, 12G=green, 12B=blue and 12Y=yellow, respectively). The left part of FIG. 1a shows the situation in which the information has a same value (all storage locations have the material). Information is represented by the presence (indicated by a colour) or absence (called 12N) of the materials, as shown in the right part of the Figure. The four types of material are arranged in a repetitive pattern, in order to have a fixed distance to a next storage location having the same material for preventing symbol interference. This allows for the readout sensor element to have a sensitive area that covers 4 storage locations, i.e. having a size that is 4 times the storage location size. The advantage is that the less sensor elements are needed, and that the size of a single sensor element is larger reducing the requirements on production thereof. As explained below the sensor element can individually detect the presence of each of the 4 materials within its sensitive area by generating a suitable varying field. In practical embodiments the particles have diameters of the order of 3 to 10 nm, so each storage area is built up of at least hundred of such particles, depending on the ratio of the storage area over the particle volume. The storage area can be reduced further (ultimately to a single particle) following the technology progress of imprinting and sensor manufacture.

FIG. 1b shows a pattern of a superparamagnetic material having grey scale coding. Some storage locations have the full amount of material, like 12R and 12B, but other storage locations have a low mount of material like 14Y and 14R. The amount of material in each location is detected by measuring the level of the response for the specific material in each storage location. In an embodiment a grey scale coding of information is to vary the size of the areas in the two orthogonal directions. The sizes can be determined according to a suitable 2-D channel code.

In an embodiment of the information carrier the pattern of superparamagnetic material has a pattern of a superparamagnetic material having combined materials as follows. The pattern of superparamagnetic material has a combination of said different superparamagnetic materials in the storage locations, the combination representing said value. Hence in the full area of a single storage location any of the different superparamagnetic materials will either be present or not (or in the amount required for grey scale coding). The materials can for example be applied by imprinting an overlapping pattern. The combined materials have the advantage that a misalignment of the read sensor is less critical as follows. For example the pattern has 4 different materials and storage locations of 1×1μ. The head (also having a sensitive area of 1×1μ), assuming substantially no rotational misalignment and 0.25μ misalignment in x or y direction, will now cover at least an area of 0.75×0.75μ of any storage location, and at most some 0.25×0.75μ of any neighboring storage location causing some interference. The interference can further be reduced by making the sensitive area of the sensor elements smaller than the pitch of the sensor array, and/or making the sensitivity in the center of the sensor higher than at the edges of the sensitive area. A similar misalignment occurring in the embodiment of FIG. 1a results in the sensor covering 0.25×0.25μ of 4 neighboring storage locations, hence maximum interference.

It is noted that, while in the embodiments discussed above the pattern of storage areas and sensitive area of the sensor are square, the shape of the storage areas and the shape of the sensor element can have any shape, e.g. rectangular. In practical designs the shape and pitch of the sensor elements in the array sets the layout rules for the storage area pattern on the information carrier.

FIG. 2a shows a patterned information carrier part in a cross section view. The information carrier has a substrate 21. An information plane 28 is constituted on the top side of the substrate 21 by a pattern of superparamagnetic material, the pattern constituting an array of storage locations. In a first storage location 22 the material is present for example indicating the logic value 1, and in a second storage location 23 the material is absent for example indicating a logic value 0. The material has a superparamagnetic property for being detectable by said sensor elements. The pattern of superparamagnetic material in the information plane 28 can be applied by well known manufacturing methods for patterned magnetic media, although it is to be noted that no permanent magnetizations are required. Suitable methods are sputtering and locally etching, ion beam patterning or pressing using a mask. For example for production first fabricate a resist mask on a bare Si wafer by means of electron-beam lithography and use this as a master. If desired, holes are etched in the Si for storing the information in the 2D hole pattern. Then, using the master, replicate the pattern on a foil, or via injection molding, or via embossing, or via 2P. Then deposit a thin superparamagnetic pattern (e.g. via sputtering) on the replica.

An embodiment fabrication of the information carrier uses imprinting technology for applying the superparamagnetic material in the information plane 28, e.g. by direct transfer of the nano-particles. For example several types of superparamagnetic particles may be applied using several stamps that are optically aligned, e.g. using transparent stamps. Alternatively, novel technologies may be used for bringing the particles of each ‘colour’ to the right regions, e.g. by attaching to each particle biological groups that binds specifically to an antibody that is attached to the substrate by nano-imprinting. In that case the deposition of bits of all colours can be carried out as a single process step in a fluid. The fast diffusion of the nano-particles makes the process extremely time effective.

FIG. 2b shows an information carrier and magnetic sensor elements. The information carrier part is constituted by a substrate 21. An information plane 28 is constituted on the top side of the substrate 21 by a pattern 22 of superparamagnetic material constituting an array of storage locations. Coils 27 are located near the information plane 28 for generating a varying magnetic field. In an embodiment a single coil is used to generate the varying magnetic field for a number or for all sensor elements. For achieving a fast readout time the coils must be controlled to generate fast changes in the varying field. Suitable coils are described in [H. W. van Kesteren et al., J. Magn. Soc. Japan 25, 334-338 (2001)]. Opposite the information plane magnetic sensor elements 24,25,26 are located for detecting the magnetic field as influenced by the superparamagnetic material, as explained below. In a first storage location opposite a first magnetic element 24 the material has a first superparamagnetic response for example indicating the logic value 1, in a second storage location opposite a second magnetic element 25 the material has a response indicating a logic value 0, and in a third storage location opposite a third magnetic element 26 the material has a response indicating a logic value 1. For example the magnetic elements 24,25,26 have a multilayer stack for detecting the magnetic field as described in detail with FIG. 6. The top layer of the multilayer stack is influenced by the response of superparamagnetic material of the storage location. The superparamagnetic material has a predefined response to a magnetic field, in particular a specific decay of magnetization after a decrease of the varying magnetic field. In an embodiment the pattern contains different superparamagnetic materials having respective different predefined responses to the varying magnetic field, in particular the different predefined responses being different decay of magnetization after a decrease of the varying magnetic field due to different relaxation times of the different superparamagnetic materials. It is noted that a single material may be detected by generating any magnetic field and detecting components in the field due to the particles, e.g. low frequency or even DC fields may be used with sensors that detect field components due to the particles.

As shown in the Figure the array of sensor elements has the same pitch as the pattern. Alternatively the pitch of the sensor elements may be n*m times larger than the pattern in x and y direction, e.g. n=m=2 for reading the pattern shown in FIG. 1a. The factors n and m are selected in dependence of the number of superparamagnetic materials and the pattern used for a system wherein the sensor elements are aligned to the pattern.

In an embodiment of the storage system the array of sensor elements is only positioned on top of the pattern, but not aligned thereto, or at most substantially oriented in a same rotational direction. Individual sensor elements now are at an arbitrary position in x and y direction above the pattern. Alternatively the alignment is performed only in one direction, e.g. the y direction, as described with reference to FIG. 4. The pattern is designed for allowing such non-aligned read-out. For example the pattern is made at a pitch that is somewhat smaller than the pitch of the sensor elements, e.g. 90%. Due to symbol interference some 10 to 30% of the storage areas cannot be read-out. Redundancy in the pattern and error correction techniques can be used to compensate for the reduced read out. In particular mark areas that are uniquely detectable are included, e.g. areas larger than storage locations having a single superparamagnetic material only. Pattern recognition and symbol interference reduction techniques are used for detecting the position of the pattern with respect to the sensor array and for detecting the values of the storage locations. In an embodiment the pattern of superparamagnetic material has areas of 4 different superparamagnetic materials arranged according to a predefined pattern of 2×2 storage areas as shown in FIG. 1a, while the array of sensor elements is adapted for non-aligned read-out. For example the sensor elements have a pitch in the array substantially being 1,5× the pitch of the storage locations. Due to the ratio of the pitch of the storage locations and the pitch of the sensors there will always be a sensor above each storage location covering at least 50% thereof in the x or y direction. At the worst case position of 50% coverage there is still no interference of the next neighboring storage location (having the same superparamagnetic material). The read signal of the two neighboring sensors both covering 50% of a storage location may be combined for further improving the readout. Some sensor elements are positioned in between storage locations, e.g. covering 25% of two neighboring storage locations of the same material. The read signal of such sensor elements can be skipped, because the next sensor element will over the storage locations for 75%. Hence after detecting the position of the sensor elements with respect to the pattern the readout can be accomplished by suitably processing the read signal, i.e. combining and eliminating read signals of different sensor elements.

In an embodiment of the information carrier the pattern of superparamagnetic material has sub-patterns in shifted positions as follows. The pattern of superparamagnetic material has a separate sub-pattern for a number of said different superparamagnetic materials, the sub-patterns each having an identical array of storage locations. Each sub-pattern stores the same information. The sub-patterns are positioned at mutually shifted positions such that a read sensor in an arbitrary position (i.e. the array of read sensors is not aligned to the pattern of a superparamagnetic material) will always be sufficiently aligned to at least one of the sub-patterns. It is noted that the sub-patterns are overlapping. For example having 4 sub-patterns having storage locations of 1×1μ: the first one is positioned at the nominal position, the second one is shifted 0.5μ in x direction (to the right), the third one is shifted 0.5μ in y direction (down) and the fourth one is shifted 0.5μ in both x and y direction. The head (also having a sensitive area of 1×1μ, and assuming substantially no rotational misalignment) will now cover at least an area of 0.75×0.75μ of one of the patterns, and at most some 0.25×0.75μ of any neighboring storage location causing some interference. The interference can further be reduced by making the sensitive area smaller than the pitch of the sensor array, and/or making the sensitivity in the center of the sensor higher than at the edges of the sensitive area. It is noted that an arrangement of n sub-patterns carrying the same information (of course) reduces the storage capacity by a factor n, but eliminates the necessity and risks of highly accurate aligning.

FIG. 3 shows a read-out unit. A read-out part 30 is intended to cooperate with the information carrier parts described above. Thereto the read-out part has an interface surface 32. The interface surface 32 is provided with an array 31 of sensor elements. The array is a two-dimensional layout of magnetic sensor units that are sensitive to the presence of said superparamagnetic material on a near-field working distance. It is noted that several combinations of a superparamagnetic material and a sensor element can be chosen. In an embodiment the sensor elements are provided with circuitry for generating a varying magnetic field and detecting the magnetic field as influenced by the presence of absence of the material having a superparamagnetic property. A suitable sensor element is based on the magneto-resistive effect. An example is described below with reference to FIG. 6. The read method is explained with reference to FIG. 7.

FIG. 4a shows a storage device (top view) and information carrier. The storage device has a housing 35 and an opening 36 for receiving an information carrier 40. The information carrier 40 includes an information carrier part 10 that has an information plane that has an array of storage locations 11 as described above with reference to FIGS. 1 and 2. Further the information carrier has alignment elements 41 for cooperating with the complementary alignment elements 38 on the device for positioning the storage locations near the sensor elements within the near-field working distance between a storage location and the corresponding sensor element during said coupling. Read-out of the information carrier is realized by providing appropriate alignment and registration during insertion of the medium in the reader device as described below. In an embodiment the alignment elements are predefined and precisely shaped parts of the outer walls of the information carrier part. It is noted that the information carrier can be substantially only the information carrier part as described above, or an assembly containing an information carrier part. For example a single substrate carrying the information plane is further shaped to accommodate the several types of alignment elements as described hereafter.

When coupling the information carrier 40 to the storage device 35 the information carrier is placed on the opening 36. The opening 36 is provided with an interface surface 32 on a read-out unit 30 as described above with reference to FIG. 3, and with alignment elements 38, for example protruding pins. The alignment elements 38, 41 are arranged for determining the position of the storage locations on the information carrier with respect to the position of the interface surface of the read-out unit 30 in planar directions parallel to the interface surface.

In an embodiment the opening 36 is a recess in the surface of the housing, the recess having precisely shaped walls as alignment elements for cooperating with the outer perimeter of the information carrier 40 for aligning the information carrier part.

In an embodiment the storage device is provided with processing circuitry for analyzing the read-out signals of the sensor elements for eliminating influences of neighboring storage locations. Any sensor element may be influenced somewhat by adjacent storage locations, in particular due to some remaining misalignment. However, by analyzing the read-out signals of neighboring sensor elements and subtracting some of those from the current read-out signal, the detected value of the current storage location is improved. Hence electronic correction of inter-symbol interference is provided. The analysis may be controlled by global information about the remaining misalignment, for example indicating which of the neighboring read-out signals must be subtracted and to which extent.

In the direction perpendicular to the interface surface some pressure is required to make sure that the distance of the storage locations to the sensor elements in the read-out part is within the near-field working distance. The pressure may be provided by a user just pressing the information carrier to the storage device, or by a resilient lid or cover on top of the information carrier (not shown). Other options for achieving close physical contact are well-known to a skilled man.

In an embodiment of the information carrier the information plane is provided on a flexible substrate. The device is provided with a pressure system for bringing the flexible substrate in close contact with the interface surface, for example by creating a low pressure or vacuum between the substrate and the interface surface. In an embodiment the device is provided with a generator for generating an attracting field for attracting the information carrier to the interface surface. The type of attracting field is different from the field used by the sensor element. For example an electrostatic field is generated for attracting the information carrier.

In an embodiment the alignment elements 38 on the device are connected to actuators for moving the information carrier with respect to the interface surface 32. Only a small movement, in the order of magnitude of the dimensions of a single storage location (i.e. a few μm or less), is sufficient to align the sensor elements with the storage locations. For the actuators several types may be used, e.g. voice coil type, piezo type or electrostatic type. In an embodiment the actuators are controlled by detecting misalignment of the storage locations. The misalignment can be derived from read-out signals of the sensor elements. For example if there is a substantial misalignment the sensor elements will cover adjacent storage locations. Read-out signals of adjacent locations having the same value will be different from read-out signals of adjacent locations having differing values. Hence if such differences occur, i.e. if the read signals of some storage locations have values at an intermediate level between the maximum and minimum levels of other storage locations, misalignment is detected. It is noted that in non correlated data the intermediate levels will occur in substantially 50% of the storage locations due to the fact that the respective neighboring location has a same or different logical value. In an embodiment predefined control patterns having known neighboring bits are included for misalignment detection. A control signal is generated to activate the actuators, and after applying the control signal the read-out signal is again analyzed. In an embodiment the information carrier is provided with optical marks for alignment, and the device is provided with separate optical sensors for detecting the optical marks for generating a misalignment signal.

In an embodiment of the information carrier the information plane is provided with position mark patterns that are unique patterns in the information plane within a predefined area of the information carrier. The pattern of superparamagnetic material is provided with such a mark pattern for detecting the position of the pattern of superparamagnetic material with respect to the array of sensor elements. Thereto the mark pattern provides a uniquely detectable pattern of areas of superparamagnetic material. For example the position mark patterns may comprise a large area of material which is larger than any initial mechanical misalignment. The large area is surrounded by a contour without material having a predetermined pattern. Hence some sensor elements will always initially be covered by said large area. By analyzing the surrounding sensor elements the misalignment can be detected easily. The storage device is provided with a processor for applying techniques of pattern recognition for detection the absolute position of the position mark patterns with respect to the sensor elements array by analyzing the signals detected from the sensor elements.

In an embodiment the array of sensor elements is substantially smaller than the information plane, e.g. 10 times smaller. The device is provided with actuators that are arranged for positioning the information carrier or the array of sensor elements at a few, e.g. 10, read-out positions for reading the total area of the information plane.

In an embodiment the alignment elements of the information carrier are constituted by oblong protruding guiding bars, and the complementary guiding elements on the device are slots or grooves. The alignment by these elements is effective in one planar dimension. Specific embodiments of the storage system do not require alignment as described above. Alternatively the alignment in the other planar dimension may be provided by a wall or protruding stopping pin on the device. Alternatively there may be no specific stopping position in the second planar dimension, but the information is retrieved from the storage locations while the information carrier is being propelled along that second direction, e.g. by the user pushing the information carrier via a guiding slot. Such constellation is advantageous for one-time reading of data from the information carrier, e.g. in an application like a personal passport carrying biomedical or DNA information for access control at an airport.

FIG. 4b shows a storage device (side view) and information carrier. The storage device has a housing 45 and an opening 43 for receiving an information carrier 40. When coupling the information carrier 40 to the storage device 45 the information carrier is placed on the opening 43. Close contact between the two parts is obtained by pressing (possibly with contact liquid) the read-out array against the information carrier when the slot of the reader is closed. The opening 43 is provided with an interface surface 32 on a read-out unit 30 as described above with reference to FIG. 3. In addition the opening 43 may be provided at either side with at least one coil (not shown) for generating the varying magnetic field. The read signals from the read-out unit are processed in a processing unit 33, e.g. a digital signal processor and software, for detecting the response of the superparamagnetic material as described below. Further the opening 43 is provided with alignment elements 42 at the inner end and outer alignment elements 44 at the entry side. The outer alignment elements 44 are arranged for clamping the information carrier. The information carrier has a protruding alignment element 41 for cooperating with the clamping outer alignment elements 44 on the device for positioning the storage locations near the sensor elements within the near-field working distance between a storage location and the corresponding sensor element during said coupling. The clamping movement may be activated by the force the user applies during entering the information carrier into the opening, or by an actuator.

FIG. 4c shows an information carrier in a cartridge. The information carrier has a cartridge 47 enclosing the information carrier part 10. The cartridge 47 has a movable cover 48 that effectively seals off the information plane from contamination (dust and fingerprints) when the information carrier is not coupled to a storage device. A storage device has an opening mechanism (not shown) for moving the cover aside during said coupling. Several options for slidable covers are known from optical or magnetic recording disc cartridges and cooperating devices.

In an embodiment the cartridge comprises a cleaning pad 46. The pad 46 is located on and/or moved by the cover 48 for wiping the information plane and/or the interface surface when the cover is moved. Alternatively the pad or other cleaning units such as a brush may be placed on the cartridge itself. In an embodiment the cartridge is provided with a dust attracting inner layer for attracting any dust particles that may have entered the closed cartridge in spite of the cover 48.

FIG. 5 shows a memory device. The memory device has a housing 51 that contains an information carrier 10 and a read-out unit 30. It is noted that the read-out unit includes means for generating the varying magnetic field such as coils (not shown), e.g. integrated on a solid state read-out unit. Electrical connectors 52 extend from the housing 51 for connecting the storage device to the outside world. As shown the parts are fixedly coupled inside the housing. During manufacture both parts are aligned for positioning the bit locations opposite the sensor elements substantially at the near-field working distance between a bit location and the corresponding sensor element. The parts are bonded together in the aligned state, e.g. by applying glue or by the encapsulation process that forms the housing. It is noted that because the memory layer is added as a last step and the reader device can be manufactured in large numbers, the manufacture of the new device leads to economies of scale. The memory layer can be replicated in desired numbers in a separate production line, and can then be bonded to the reader chips using for example a wafer bonding process. Alternatively the information plane can be stamped or imprinted on the interface surface of a read-out unit just before encapsulating the unit in the housing 51.

FIG. 6 shows a sensor element in detail. The sensor has a bit line 61 of an electrically conductive material for guiding a read current 67 to a multilayer stack of layers of a free magnetic layer 62, a tunneling barrier 63, and a fixed magnetic layer 64. The stack is build on a further conductor 65 connected via a selection line 68 to a selection transistor 66. The selection transistor 66 couples said read current 67 to ground level for reading the respective bit cell when activated by a control voltage on its gate. The magnetization directions 69 present in the fixed magnetic layer 64 (also called pinned layer) and the free magnetic layer 62 determine the resistance in the tunneling barrier 63, similar to the bit cell elements in an MRAM memory. The magnetization in the free magnetic layer is determined by the material at the storage location opposite the sensor as described above with FIG. 2B, when such material is within the near-field working distance indicated by arrow 60.

For the sensor elements, because of the different requirements compared to those for MRAM, the composition and characteristics of the spin-tunnel junctions are adapted compared to those used for MRAM. While for MRAM two stable magnetization configurations (i.e. parallel and antiparallel) are essential for the storage; the proposed sensor element should contain one layer with stable magnetization and one layer with free magnetization. Of course the direction of the reference magnetization, e.g. in the pinned or exchange-biased layer should be invariant. Hence for the free layer, which acts as sense layer, materials with a low coercivity should be chosen. In an embodiment a number of sensor elements are read at the same time. The addressing of the bit cells is done by means of an array of crossing lines.

The magnetic field due to the response of the superparamagnetic material results in a different magnetic direction in the sense layer of the sensor element. The direction is detected in sensor elements having a multilayer or single layer stack by using a magneto-resistive effect, for example GMR, AMR or TMR. The TMR type sensor is preferred for resistance matching reasons for the sensor element of this invention. Coils or other current leads for generating the varying bias field can be integrated with the sensor elements. Many variants are possible for generating the bias fields as will be clear for the person skilled in the art. While the given examples use magnetoresistive elements with in-plane sensitivity it is also possible to use elements that are sensitive to perpendicular fields. For a further description of sensors using magnetoresistive effects refer to “Magnetoresistive sensors and memory” by K.-M. H. Lenssen, as published in “Frontiers of Multifunctional Nanosystems”, page 431-452, ISBN 1-4020-0560-1 (HB) or 1-4020-0561-X (PB).

FIG. 7 shows a varying field and responses. A rectangular pulse shaped curve 71 indicates the varying field. The response curves for three types of particles are shown: fast (red) particle curve 72R, targeted (green) particle curve 72G and slow particle curve 72B. The read-out method is as follows. The information carrier is sandwiched in between the array of heads and an array of current coils, which are used to generate a high local in-plane or perpendicular field. The induced magnetization is then in-plane or perpendicular. Most generally, the contributions to the signal from storage locations having particles with different relaxation times can be distinguished by a measurement of the decay of the magnetization that has been induced by the application of the external field. In an embodiment the detection is carried out when the applied field is off, so that the sensor is not biased by the applied field. However, it is also possible to use a geometry in which the applied field is perpendicular to the sensitivity direction of the sensor, so that a measurement can be done with the field on. The varying field curve can be chosen in order to be able to optimally distinguish the contributions from the different types (called ‘colours’) of superparamagnetic materials. A straightforward method is depicted in FIG. 7. The coils generate the varying field 71 that is periodically positive-off-negative-off. The duration of each phase is T, so the period is 4T. The sensor measures the average signal during the off-state. In an embodiment instead of the average a more detailed signal processing is applied to detect the contributions of each superparamagnetic material to the total detected field. Below the time dependent response of the superparamagnetic particles is calculated within the Neél-Arrhenius theory. It is shown in FIG. 9 that the average signal from particles with a relaxation time τ, normalized by the steady state signal obtained in a static field, is strongly peaked for pulse widths Tₘₐₓ≈1.5 τ. Pulse widths that are a factor of 10 (100) larger or smaller lead to a reduction of the signal by approximately a factor of 5 (50). The time dependent magnetization is shown in FIG. 7, where the pulse period is ‘tuned’ to the relaxation time of the ‘green’ particles. The average response signal 72R from the red particles and the signal 72B from the blue particles, with particles have much smaller (red) and larger (blue) relaxation times, respectively, are smaller.

In a practical example each sensor senses n types of material ‘colours’) and a certain time Tₜₒₜ is available for the readout of each sensor. If N is the number of sensors that is read out in parallel, the overall bit rate is b=nN/Tₜₒₜ. The concept allows the use of massively parallel readout, i.e. very large N. For each type the maximum in the (narrow) distribution of responses (relaxation times) is precisely known. The application of the method explained above requires that n measurements are performed of the average magnetization during the field-off period using pulse widths Tᵢ (i=1 to n). An equal signal-to-noise ratio (SNR) is obtained for all types if the total duration of these measurements is equal for all i. In that case the minimum time during which the actual measurements take place is equal to nTₙ, if i=n is the class for which the relaxation time is largest. It is noted that a shorter time can be used if the SNR is sufficiently high for the types with shorter relaxation times. However, before a measurement can start, the system must be brought in a dynamic equilibrium at the measurement frequency in order to minimize any initial state effect. Again, the type of particles with the longest relaxation time determines the time required to get rid of initial state effects. A reasonable accuracy may already be reached when the shortest possible initialization sequence is used, with a duration of 3Tₙ. For i=n this corresponds to applying the field pattern shown in FIG. 7 in between t₀ to t₃. Before performing measurements at the other periods, much larger numbers of field cycles are applied within the same time interval 3Tₙ before the final measurement is done. In that case, Tₜₒₜ=4nTₙ≈6nτₙ.

In a numerical example b=1 Gb/s and n=4 (as shown in FIG. 1a). It follows from the theory of superparamagnetism that the minimum relaxation time is of the order of 0.1-1 ns (see below). However, the practical minimum relaxation time is determined by the maximum pulse frequency of the magnetizing coil, for example in a practical design that could allow a minimum pulse length of 3 ns and hence a minimum relaxation time of 2 ns. Currently superparamagnetic nano-particles can be fabricated with almost non-overlapping relaxation time distribution functions if their average relaxation times are different by at least a factor of 10. In the example the relaxation times are equal to 2, 20, 200 and 2000 ns. Tₜₒₜ is then equal to 48 μs, an N=12000. It is to be noted that more accurate fabrication of the particles or more complicated detection methods may allow a smaller factor between the relaxation times.

Within the phenomenological theory given below the relaxation time (in zero field) is given by τ=(τ₀/2)exp(KV/kT). The parameter τ₀ is the inverse of the attempt frequency, ν₀, for thermally induced switches of the magnetization over an energy barrier KV, where K is the effective uniaxial magnetic anisotropy of the particle and V is the volume. Let us assume that τ₀=0.67 ns. The ratios KV/kT for our four classes of particles should then be equal to approximately 1.8, 4.1, 6.3 and 8.7 (see also FIG. 8). These numbers show that the KV product of the particles should have a distribution with a half-width at half maximum that is smaller than 15% of the peak value. If the variation is due to a volume variation, the radius must be precise within 5%. This is nowadays possible using chemically prepared nano-particles. An example can be found in a publication by Sun et al. [Science 287, p. 1989 (1999)] on superparamagnetic Fe—Pt particles with high saturation magnetizations. The fabrication and characterization of 3 to 10 nm diameter particles is described with a standard deviation in the radius of less than 5%. For the present application the effective K can be estimated and, combined with the known small width of the distribution of the particle volumes, provides particles having the required set of relaxation times. Similar degrees of monodispersity are possible for other alloys.

In an embodiment the read-out method includes further processing of the read out signal. The read out method described above is straightforward and allows a simple mathematical analysis of the measured flux based on the average flux in the field-off phase. However, it is not efficient from the point of view of the total measurement time per sensor. For more optimal schemes that time should be much closer to the minimum value Tₜₒₜ≈Tₙ. This aim can be approached when measuring the time dependence of the signal during the field-off phases, instead of only the average signal. That makes it possible to determine the contributions from each class, for any initial condition of their magnetization.

In an embodiment called thermally assisted read-out the read-out method includes locally heating the information carrier, e.g. by a laser. The use of a transparent substrate allows to locally heat the medium through the substrate and, if necessary, through the field coils. Heating can be used in the following ways. In a first embodiment heating is used in order to quickly prepare a well defined initial state by a field cooling or a zero-field cooling procedure. The temperature is then increased only during a first pre-measurement phase. In a second embodiment heating is used for enhancement of the range of relaxation times, by allowing detection of particles which, at room temperature, have a relaxation time that is too large. The temperature is then increased during part of the measurement phase, or during the entire measurement phase. In a further embodiment the temperature is modulated according to a predefined pattern during the measurement phase to detect several types of responses of superparamagnetic particles.

In order to explain the read out method quantitatively, first the theory of thermally activated response of superparamagnetic particles to a change of the applied field H is discussed. The so-called Néel-Arrhenius model assumes that the particles have a uniaxial magnetic anisotropy, and that the applied field is parallel to the easy axis. From magnetic recording theory it is known that corrections for general alignments do not give a qualitatively different picture of the physics involved. When the field is sufficiently strong, the states with magnetizations parallel and antiparallel to the fields are stable and metastable, respectively. The static and dynamic properties are characterized by two dimensionless parameters:

$$x ≡ \frac{{μ}_{0} MVH}{{k}_{B} T} and y ≡ \frac{KV}{{k}_{B} T} , \qquad ( A1 )$$

where M is the saturation magnetization, K is the (effective) uniaxial anisotropy constant, and V is the particle volume. In a steady magnetic field and at a constant temperature T the equilibrium magnetic moment is determined by the parameter x:

$$m = ( coth ( x ) - \frac{1}{x} ) MV , \qquad ( A2 )$$

which approaches the saturation moment MV when x>>1, and which is approximately equal to (x/3)MV when x<<1. The factor in between parentheses in eq. (2) is called the Langevin function, L(x). After a sudden change of the magnetic field, the response of the magnetization is an exponential function of the time, characterized by the relaxation time

$$τ = {τ}_{0} ( \frac{1}{exp ( - {e}_{1} ) + exp ( - {e}_{2} )} ) , \qquad ( A3 )$$

where the dimensionless energy barriers e₁ and e₂ are given by

$${e}_{1 , 2} = y ( 1 + \frac{{x}^{2}}{4 {y}^{2}} ) \pm x . \qquad ( A4 )$$

These are the energy barriers, normalized by kT, for excitations from the stable to the metastable state, and vice versa. When y<0.5x there is no energy barrier, and the theory is not applicable.

FIG. 8 shows contours of the ratio τ/τ₀. Contours 81 of equal τ/τ₀ as a function of the parameters x and y are defined in equation (A1) given above. In the shaded area 82 there is no energy barrier. If τ/τ₀=0.67 ns, as in the example given above, these contours correspond to τ=2, 20, 200 and 2000 ns. Contours of equal values are given as a function of x and y defined above. It is known from experimental work that the parameter τ₀ is typically equal to 1 ns for many magnetic materials. In that case the four contours that are shown in FIG. 8 correspond to relaxation times equal to 2, 20, 200 and 2000 ns, corresponding to the example given in the main text. It will be shown below that the system is most likely to operate in the regime in which the magnetizing fields are relatively small (x<1). The relaxation time then depends only weakly on the applied field.

The (ensemble averaged) magnetic moments of the particles at times t₁ and t₂ (see FIG. 7) are given by

$$\begin{matrix}{m}_{1} = m \frac{1 - exp ( - T / τ )}{1 + exp ( - 2 T / τ )} , and & ( A5 ) \\ {m}_{2} = m \frac{1 - exp ( - T / τ )}{1 + exp ( - 2 T / τ )} exp ( - T / τ ) , & ( A6 )\end{matrix}$$

where m is the steady state average magnetic moment at the field and temperature used.

FIG. 9 shows the average medium magnetization in the field=off phase. The average magnetization curve 91 is given with respect to the steady state magnetization with the magnetizing field=on, and at the same temperature, as a function of the ratio T/τ. T is the pulse length (see FIG. 7) and τ is the relaxation time at x=0. The average magnetization in the time interval [t₁,t₂] is given by

$${m}_{av} = m \frac{{( 1 - exp ( - T / τ ) )}^{2}}{1 + exp ( - 2 T / τ )} \frac{τ}{T} . \qquad ( A7 )$$

A pronounced maximum is situated close to T=1.5τ. In the maximum, the time-averaged magnetization is about 0.38 times the maximum possible value at the field and temperature used. The use of the pulse method thus costs a factor of about 2.6 signal amplitude. However, the gain is a strong reduction of the contributions to the signal from particles with a relaxation time that is not equal to the maximum. The relative reduction is a factor of approximately 5 (50) for particles with 10 (100) times larger or smaller relaxation times.

The variation of the relaxation time of the nano-particles can be accomplished by varying K or V. This provides a certain degree of freedom of the system design. Let us consider as an example the case of four classes of particles with equal saturation magnetic moments, with equal particle volumes (equal x, and y different due to different values of K), and with (as in the example given in the main text) KV values in the range 1 to 10. The equal values of x assure that the steady state contributions of areas of each ‘colour’ to the measured flux are then equal. Typical experimental values of K can be of the order in between 10³ and 10⁷ J/m³, e.g. for Fe K=4×10⁴ J/m³ and for Co K=4×10⁵ J/m³.

FIG. 10 shows parameters of the superparamagnetic particles. FIG. 10A shows parameter x as a function of the particle radius, for a series of values of the applied magnetic field, using Mₛₐₜ=1200 kA/m. FIG. 10B shows parameter y as a function of the particle radius, for a series of values of the magnetic anisotropy energy density K. T=300 K. A typical example of a set of system parameters is given by the gray areas 101,102, as follows. FIG. 10B shows particles with a radius of 5 nm and with a range of K values from 1×10⁴ J/m³ to 1×10⁵ J/m³ in the grey area 102 that would be suitable. B fields of the order of 0.01 T are then required in order to realize a magnetization that is not too far from saturation, i.e. a value of x close to 1, as shown in grey area 101 FIG. 10A. For x>>1 the relaxation time during the field=on phases will be significantly smaller than during the field=off phases, leading to a significantly wider peak in the T/τ dependence of the average magnetization during the field=off period than shown in FIG. 9. Note that the average magnetization in the field=off phase increases with increasing x, in particular for T/τ<1. The specificity of the ac detection method therefore fails for x>>1. However, in practice it will be difficult to generate ac B fields that are much larger than 0.01 T. Therefore, x will be close to 1 or smaller, so that the curves shown in FIG. 9 are a good approximation.

The memory device according to the invention is in particular suitable for the following applications. A first application is a portable device that needs removable memory, e.g. a laptop computer or portable music player. The storage device has low power consumption, and instant access to the data. The information carrier can also be used as a storage medium for content distribution. A further application is a memory that is very well copyright-protected. The protection benefits from the fact that no recordable/rewritable version of the information carrier exists and a consumer reasonably cannot copy the read-only information carrier, and from the fact that without the (correct) varying field reading the information carrier is not possible. For example this type of memory is suitable for game distribution. In contrast to existing solutions it has all the following properties: easily replicable, copy-protected, instant-on, fast access time, robust, no moving parts, low power consumption, etc.

Although the invention has been mainly explained by embodiments using decay times of superparamagnetic material, any type of response to a magnetic field can be used. Further for the sensor elements the embodiments show magneto-resistive sensors, but any type of magnetic sensor may be used, such as coils. It is noted, that in this document the verb ‘comprise’ and its conjugations do not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Storage system comprising a information carrier and a storage unit,
the information carrier (40) having an information plane (28) that is provided with a pattern of superparamagnetic material constituting an array of storage locations (11), the presence of a specific superparamagnetic material at the information plane (28) representing a value of a storage location, the specific superparamagnetic material having a predefined response to a varying magnetic field,
and
the storage unit having an interface surface (32) for cooperating with the information plane (28), which interface surface is provided with field generating means (27) for generating the varying magnetic field, and with an array of magnetic sensor elements (24,25,26) each having a sensitive area for generating a read signal, and a processing unit (33) for detecting said presence via the predefined response by processing the read signal.

2. System as claimed in claim 1, wherein the pattern of superparamagnetic material comprises a number of different superparamagnetic materials, the different superparamagnetic materials having respective different predefined responses to the varying magnetic field, in particular the different predefined responses being different decay of magnetization after a decrease of the varying magnetic field due to different relaxation times of the different superparamagnetic materials.

3. System as claimed in claim 2, wherein the pattern of superparamagnetic material comprises areas of different superparamagnetic materials arranged according to a predefined pattern.

4. System as claimed in claim 2, wherein the pattern of superparamagnetic material comprises a combination of said different superparamagnetic materials in at least one of the storage locations, the combination representing said value.

5. System as claimed in claim 2, wherein the pattern of superparamagnetic material comprises a separate pattern for each of said number of different superparamagnetic materials, the separate patterns each having separate storage locations, which separate storage locations are positioned at mutually shifted positions.

6. System as claimed in claim 1, wherein the sensitive area of an magnetic sensor element (24,25,26) corresponds to an area of a number of storage locations.

7. System as claimed in claim 6, wherein the pattern of superparamagnetic materials comprises a number of different superparamagnetic materials, the different superparamagnetic materials having different predefined responses to the varying magnetic field, and said number of storage locations corresponds to said number of different superparamagnetic materials.

8. System as claimed in claim 6, wherein the magnetic sensor elements (24,25,26) have a pitch in the array substantially not corresponding integral number of storage locations, in particular the pattern of superparamagnetic material comprising areas of 4 different superparamagnetic materials arranged according to a predefined pattern of 2×2 storage areas and said pitch being 1,5× the pitch of the storage locations.

9. System as claimed in claim 1, wherein the processing unit (33) for detecting said presence by processing the read signal is arranged for detecting a response in the read signal in a period following a decrease in the varying magnetic field.

10. System as claimed in claim 9, wherein the processing unit (33) for detecting said presence by processing the read signal is arranged for detecting a response in a combination of read signals of several sensor elements (24,25,26).

11. System as claimed in claim 1, wherein the processing unit (33) for detecting said presence by processing the read signal is arranged for detecting the position of a sensor element with respect to a storage location in the pattern of superparamagnetic material, and
for generating a position error signal indicative of a misalignment of the sensor element, and/or
for compensating interference of neighboring storage locations in dependence of the detected position.

12. System as claimed in claim 1, wherein the pattern of superparamagnetic material is provided with a mark pattern for detecting the position of the pattern of superparamagnetic material with respect to the array of a sensor elements, the mark pattern providing a uniquely detectable pattern of areas of superparamagnetic material.

13. System as claimed in claim 12, wherein the mark pattern comprises sync areas of superparamagnetic material, which sync areas are larger than the storage locations.

14. System as claimed in claim 12, wherein the processing unit (33) for detecting said presence by processing the read signal is arranged for detecting the mark pattern.

15. System as claimed in claim 1, wherein the means (27) for generating the varying magnetic field are arranged for generating a pulsed magnetic field, in particular including periods having substantially no magnetic field.

16. System as claimed in claim 15, wherein the pulsed magnetic field comprises pulses of different pulse lengths, in particular for detecting different predefined responses being different decay of magnetization due to different relaxation times of different superparamagnetic materials.

17. System as claimed in claim 1, wherein the means (27) for generating the varying magnetic field are arranged for generating the field substantially in a direction perpendicular to a sensitivity direction of the sensor elements.

18. System as claimed in claim 1, wherein the storage unit is provided with heating means for locally heating the information plane.

19. System as claimed in claim 1, wherein the information carrier (40) can be coupled to and removed from the storage unit, and the system having alignment means (38,41) for positioning the storage locations near the sensor elements within a near-field working distance between a storage location and the corresponding sensor element during said coupling.

20. Information carrier for storing information, the information carrier having an information plane that is provided with a pattern of superparamagnetic material constituting an array of storage locations (11), the presence of a specific superparamagnetic material at the information plane representing a value of a storage location, the specific superparamagnetic material having a predefined response to a varying magnetic field.

21. Information carrier as claimed in claim 20, wherein the substrate is of a flexible material for allowing positioning of the storage locations near the sensor elements (24,25,26) within the near-field working distance between a storage location and the corresponding sensor element.

22. Information carrier as claimed in claim 20, wherein the information carrier comprises a cartridge (47) having an opening for exposing the information plane when coupled to the device and a cover (48) for closing the opening when removed from the device.

23. Storage device for reading an information carrier as claimed in claim 20, characterized in that the device comprises an interface surface (32) for cooperating with the information plane, which interface surface is provided with field generating means for generating the varying magnetic field, and with an array of magnetic sensor elements (24,25,26) each having a sensitive area for generating a read signal, and a processing unit (33) for detecting said presence via the predefined response by processing the read signal.

24. Device as claimed in claim 23, wherein the processing unit (33) for detecting said presence by processing the read signal is arranged for detecting a response in the read signal in a period following a decrease in the varying magnetic field.

25. Device as claimed in claim 23, wherein the array of sensor elements has substantially less sensor elements then the total number of storage locations of the information carrier, and the device comprises alignment means (42,44) for positioning said array or the information carrier at different alignment positions that in combination cover the total number of storage locations.
